(19) United States
(12) Patent Application Publication
(10) Pub. No.: US 2016/0188680 A1
(43) Pub. Date: Jun. 30, 2016

(54) ELECTRONIC DEVICE AND INFORMATION SEARCHING METHOD FOR THE ELECTRONIC DEVICE

(71) Applicant: Chiun Mai Communication Systems, Inc., New Taipei (TW)

(72) Inventor: WEI-RUNG CHEN, New Taipei (TW)

(21) Appl. No.: 14/721,456

(22) Filed: May 26, 2015

(30) Foreign Application Priority Data
Dec. 24, 2014 (CN) 201410813409.5

(51) Int. Cl. G06F 17/30

(52) U.S. Cl. CPC G06F 17/30554; G06F 17/30876

(57) ABSTRACT

In an information searching method for an electronic device an image is read from a storage device and a keyword corresponding to the read image is received by the electronic device. The read image is transmitted to a server which provides an image searching function. The method acquires result-of-search pictures which match the read image and source URLs of the result-of-search pictures from the server. The method analyzes data on web pages of the acquired source URLs and obtains groups of matching information which match the received keyword according a preset searching rule corresponding to the received keyword in the storage device. The method further determines optimal matching information with the highest occurrence frequency in the groups of matching information to be output as a search result.

### CROSS-REFERENCE TO RELATED APPLICATIONS

This application claims priority to Chinese Patent Application No. 201410813409.5 filed on Dec. 24, 2014, the contents of which are incorporated by reference herein.

### FIELD

The subject matter herein generally relates to searching technology, and particularly to an electronic device and an information searching method for the electronic device.

### BACKGROUND

Information searching is important for a user to acquire desired information. Generally, the user can input one or more keywords and search for information related to the input keywords. The user also can input an image and searches for images which is the same as or similar to the input image. However, when the user wants to know some specific information about the image, for example, a name or prices of an object in the image, the user needs to find all of information from the image according to the his/her own determination, and find the specific information according to all of the found information by himself/herself. The specific information about the image cannot be acquired accurately and conveniently according to the abovementioned traditional searching method.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of an example embodiment of an electronic device.

FIG. 2 is a block diagram of an example embodiment of an information searching system in the electronic device of FIG. 1.

FIG. 3 is a diagrammatic view of an example embodiment of searching for information.

FIG. 4 is a flowchart of an example embodiment of an information searching method of the electronic device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules can be embedded in firmware, such as in an erasable programmable read only memory (EPROM). The modules described herein can be implemented as either software and/or computing modules and can be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series, and the like.

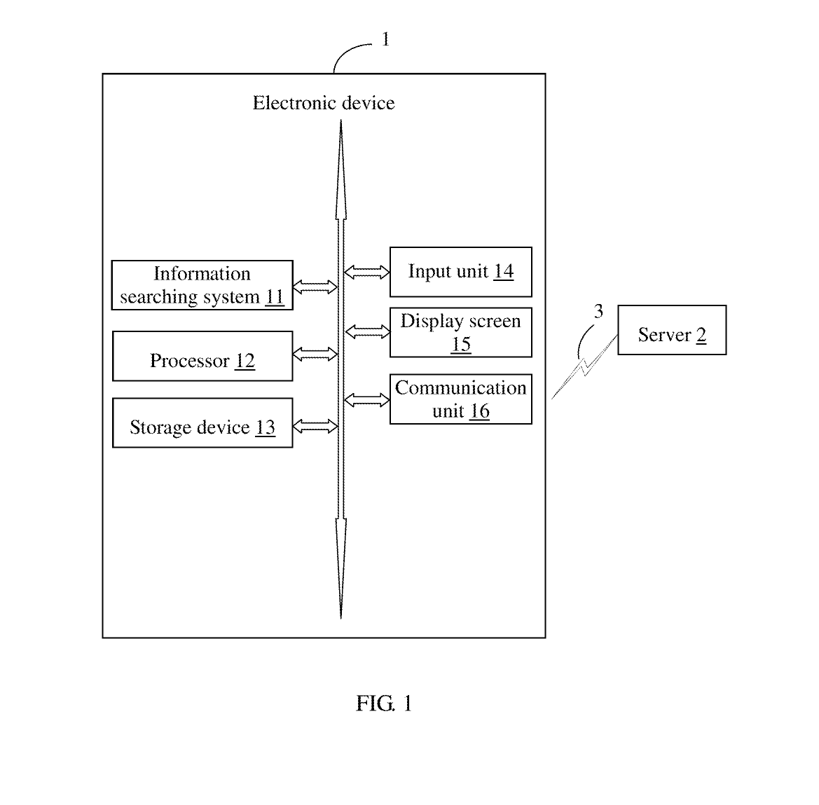

FIG. 1 illustrates a block diagram of an example embodiment of an electronic device. In at least one embodiment as shown in FIG. 1, an electronic device 1 can include, but is not limited to, an information searching system 11, at least one processor 12, a storage device 13, an input unit 14, a display screen 15, and a communication unit 16. FIG. 1 illustrates only one example of the electronic device 1, other examples can comprise more or fewer components than those shown in the embodiment, or have a different configuration of the various components.

The at least one processor 12 executes one or more computerized codes and other applications of the electronic device 1 to provide functions of the electronic device 1. The storage device 13 can be an internal storage device, such as a random access memory (RAM) for temporary storage of information, and/or a read only memory (ROM) for permanent storage of information. The storage device 13 can also be an external storage device, such as an external hard disk, a storage card, or a data storage medium. The storage device 13 can store a plurality of images downloaded or captured by the electronic device 1. The input unit 14 can receive input such as keywords or images. The input unit 14 can be a physical keyboard or a virtual keyboard. The display screen 15 can display data from the electronic device 1, for example, the stored images.

In at least one embodiment, the electronic device 1 is connected to a server 2 through a network 3 (for example, the Internet or an intranet). The electronic device 1 can transmit data to the server 2 and receive data from the server 2 via the communication unit 16. The server 2 can be a cloud server. In at least one embodiment, the server 2 provides an image searching function. When the electronic device 1 transmits an image to the server 2 for searching, the server 2 can search in the Internet or the Intranet for one or more pictures matching the image, and transmit the result-of-search pictures and corresponding source uniform resource locators (URLs) of the result-of-search pictures to the electronic device 1 via the network 3. The aforementioned one or more pictures matching the image means one or more pictures which are the same as or similar to the image.

In at least one embodiment, the storage device 13 stores a plurality of keywords and preset searching rules corresponding to each of the keywords. For example, if a keyword is “price”, a corresponding preset searching rule can be defined to be, but is not limited to, searching for information (for example, a number string) between keywords of “the price is” and a keyword of “dollars”. If the keyword is “name”, a corresponding preset searching rule can be defined to be, but is not limited to, searching for information (for example, a character string) between the keywords of “name is” or “is named” and the keyword of “,”. It should be understood that, the preset searching rules corresponding to each keyword can be preset according to statistics and integration of information which matches each keyword used in the image searching function. The preset searching rules can be modified or updated according to actual requirements in real time.

In at least one embodiment, the information searching system 11 can receive an image and a keyword corresponding to the image for executing a hybrid searching method, and can search for specific information about the input image which corresponds to the input keyword.

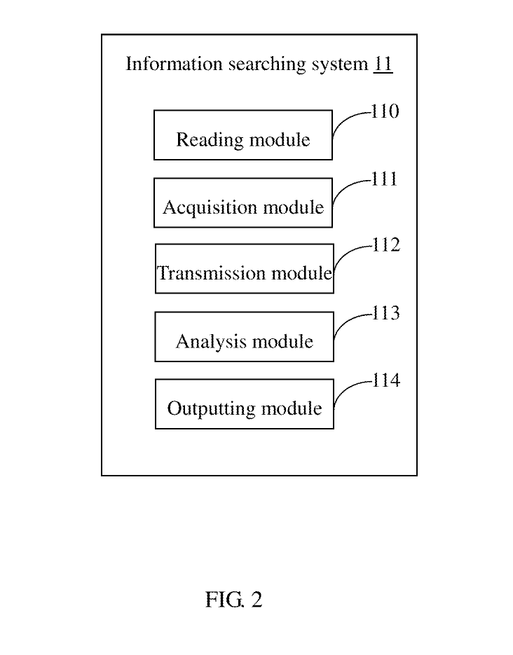

FIG. 2 illustrates a block diagram of an example embodiment of an information searching system in the electronic device of FIG. 1. In at least one embodiment, the information searching system 11 can include, but is not limited to, a reading module 110, an acquisition module 111, a transmission module 112, an analysis module 113, and an outputting module 114. The modules 110-114 can include computerized instructions in the form of one or more computer-readable programs that can be stored in a non-transitory computer-readable medium, such as the storage device 13, and be executed by the at least one processor 12 of the electronic device 1.

The reading module 110 reads an image from the storage device 13. When a user wants to know some specific information concerning an image, the user can import the image from the storage device 13 to be read for an image searching function. In another embodiment, when the user wants to know some specific information of an object, the user can use a camera (not shown) of the electronic device 1 to capture an image of the object to be read for the image searching function.

The acquisition module 111 receives a keyword corresponding to the read image. In at least one embodiment, the user can input the keyword through the input unit 14 based on what kind of information the user wants to know. For example, if the user wants to know a name of an object in the image, the user can input the keyword of “name”. If the user wants to know a price of an object in the image, the user can input the keyword of “price”.

In other embodiments, after the acquisition module 111 receives the keyword, the acquisition module 111 can firstly determine whether the received keyword is identical to one of the plurality of keywords in the storage device 13. If the received keyword is not identical to any one of the plurality of keywords in the storage device 13, the acquisition module 111 can prompt the user to reenter the keyword again, or provide one or more related keywords to replace the received keyword.

The transmission module 112 transmits the read image to the server 2. After the server 2 receives the read image from the electronic device 1, the server 2 can transmit result-of-search pictures with corresponding source URLs to the electronic device 1 via the network 3. The result-of-search pictures are the same as the read image or are similar to the read image, that is, the result-of-search pictures substantially match the read image.

The acquisition module 111 further acquires the result-of-search pictures and source URLs of the result-of-search pictures from the server 2.

The analysis module 113 analyzes data on web pages of the acquired source URLs of the pictures, and obtains, from the data on the web pages, a plurality of groups of matching information which matches the received keyword, according to the received keyword and preset searching rules corresponding to the plurality of keywords in the storage device 13. In at least one embodiment, the analysis module 113 can determine a preset searching rule corresponding to the received keyword, and search for the groups of matching information which conform to the preset searching rule from the web pages of the source URLs.

The analysis module 113 further outputs the matching information with the highest occurrence frequency among all groups of the matching information as optimal matching information. In at least one embodiment, the analysis module 113 can count occurrence frequency of each group of matching information, and select one group of matching information which appears most frequently on the web pages as the optimal matching information. The analysis module 113 can further calculate the percentage of the optimal matching information in all of the groups of matching information.

The outputting module 114 outputs the optimal matching information as a search result with a preset format on the display screen 15. The outputting module 114 can output the search result including the optimal matching information and the percentage of the optimal matching information.

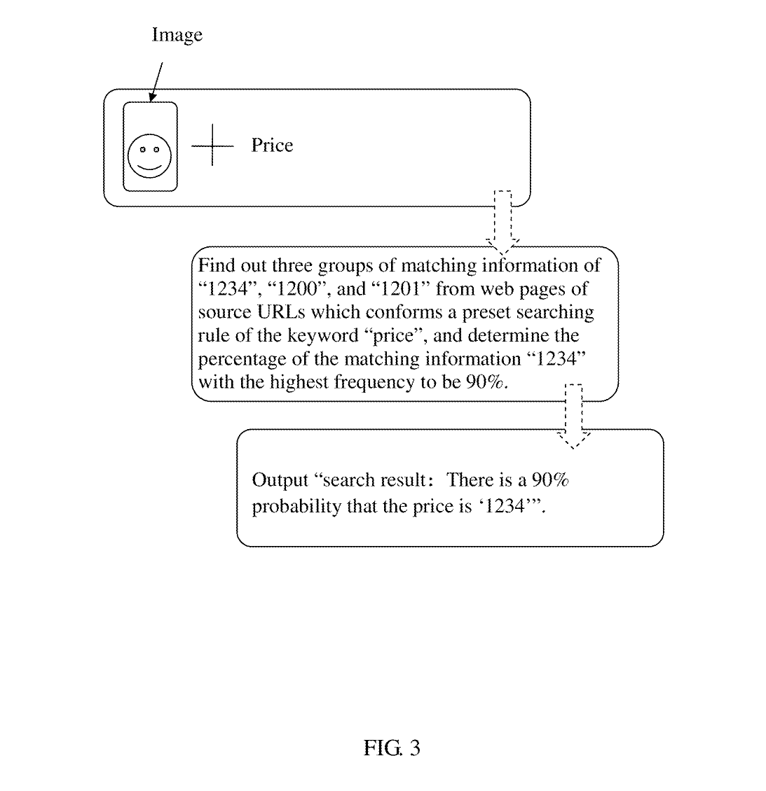

As shown in FIG. 3, after the user inputs an image and the keyword of “price”, the analysis module 113 finds out three groups of matching information of “1234”, “1200”, and “1201”, which conforms the preset searching rule of the keyword “price”, from web pages of the source URLs of the pictures matching the image. The analysis module 113 determines that the group of matching information of “1234” has the highest occurrence frequency of appearance on the web pages and further determines that the percentage of the group of matching information “1234” is 90%. The outputting module 114 can output a search result of “there is a 90% probability that the price is ‘1234’” on the display screen 15.

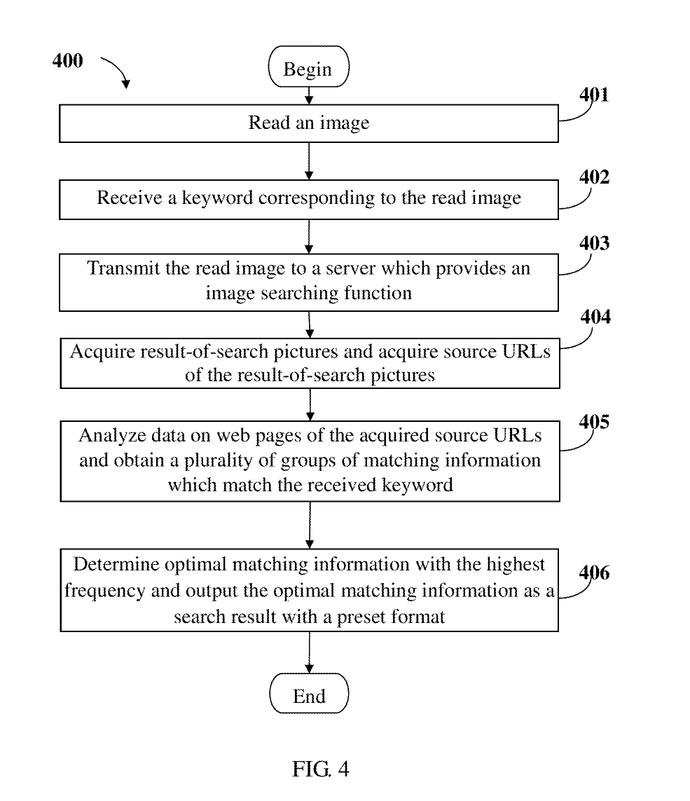

Referring to FIG. 4, a flowchart is presented in accordance with an example embodiment. An example method 400 is provided by way of example, as there are a variety of ways to carry out the method. The example method 400 described below can be carried out using the configurations illustrated in FIGS. 1-3, for example, and various elements of these figures are referenced in explaining the example method 400. Each block shown in FIG. 4 represents one or more processes, methods, or subroutines, carried out in the example method 400. Furthermore, the illustrated order of blocks is illustrative only and the order of the blocks can be changed. Additional blocks can be added or fewer blocks can be utilized without departing from this disclosure. The example method 400 can begin at block 401.

At block 401, a reading module reads an image for the image searching function from the storage device 13. When a user wants to know specific information of one image, the user can import the image from the storage device 13 to be read for the image searching function. In other embodiment, when the user wants to know specific information of an object, the user can use a camera (not shown in FIG. 1) of the electronic device 1 to capture an image of the object to be read for the image searching function.

At block 402, an acquisition module receives a keyword corresponding to the read image through the input unit 14. In at least one embodiment, the user can input the keyword by the input unit 14 based on what kind of information the user wants to know. For example, if the user wants to know a name of an object in the image, the user can input the keyword of “name”. If the user wants to know a price of an object in the image, the user can input the keyword of “price”.

At block 403, a transmission module transmits the read image to the server 2. After the server 2 receives the read image from the electronic device 1, the server 2 can transmit result-of-search pictures with corresponding source URLs to the electronic device 1 via the network 3. The result-of-search pictures are the same as the read image or are similar to the read image. That is, the result-of-search pictures match the read image.

At block 404, the acquisition module acquires the result-of-search pictures and source URLs of the result-of-search pictures from the server 2.

At block 405, an analysis module analyzes data on web pages of the acquired source URLs and obtains a plurality of groups of matching information which matches the received keyword from the data on the web pages, according to the received keyword and preset searching rules corresponding to the plurality of keywords in the storage device 13. In at least one embodiment, the analysis module 113 can determine a preset searching rule corresponding to the received keyword, and searches for the groups of matching information from the web pages of the acquired source URLs which conform to the determined preset searching rule.

At block 406, the analysis module further outputs the matching information with the highest occurrence frequency among all groups of the matching information as optimal matching information. An outputting module outputs the optimal matching information as a search result with a preset format on the display screen 15. In at least one embodiment, the analysis module can count occurrence frequency of each group of matching information, and select one group of matching information which appears most frequently on the web pages as the optimal matching information. The analysis module can further calculate the percentage of the optimal matching information in all of the groups of matching information. The outputting module can output the search result including the optimal matching information and the percentage of the optimal matching information.

All of the processes described above can be embodied in, and fully automated via, functional code modules executed by one or more general purpose processors such as the processor 12. The code modules can be stored in any type of non-transitory readable medium or other storage device such as the storage device 13. Some or all of the methods can alternatively be embodied in specialized hardware. Depending on the embodiment, the non-transitory readable medium can be a hard disk drive, a compact disc, a digital versatile disc, a tape drive, or other storage medium.

The described embodiments are merely examples of implementations, and have been set forth for a clear understanding of the principles of the present disclosure. Variations and modifications can be made without departing substantially from the spirit and principles of the present disclosure. All such modifications and variations are intended to be included within the scope of this disclosure and the described inventive embodiments, and the present disclosure is protected by the following claims and their equivalents.

What is claimed is:

1. A computer-based information searching method for an electronic device, the method being executed by at least one processor of the electronic device, the method comprising:
reading an image from a storage device of the electronic device;
receiving a keyword corresponding to the read image;
acquiring source uniform resource locators (URLs) of result-of-search pictures which match the read image;
analyzing data on web pages of the acquired source URLs, and obtaining, from the data on the web pages, a plurality of groups of matching information which matches the received keyword and conforms to a preset searching rule corresponding to the received keyword in the storage device;
determining optimal matching information with the highest occurrence frequency in the plurality of groups of matching information; and
outputting the optimal matching information as a search result with a preset format on a display of the electronic device.

2. The method of claim 1, wherein the storage device stores a plurality of keywords and preset searching rules corresponding to each of the keywords, wherein the preset searching rules corresponding to each of the keywords are preset according to statistics and integration of information that matches each of the keywords.

3. The method of claim 2, further comprising:
determining whether the received keyword is identical to one of the plurality of keywords in the storage device; and
prompting to reenter the keyword or providing one or more related keywords to replace the received keyword when the received keyword is not identical to any one of the plurality of keywords in the storage device.

4. The method of claim 1, further comprising:
calculating a percentage of the optimal matching information in the groups of match information, wherein the search result comprises the percentage of the optimal matching information.

5. A non-transitory computer-readable medium having stored thereon instructions that, when executed by at least one processor of an electronic device, causing the electronic device to perform an information searching method, the method comprising:
reading an image from a storage device of the electronic device;
receiving a keyword corresponding to the read image;
acquiring source uniform resource locators (URLs) of result-of-search pictures which match the read image;
analyzing data on web pages of the acquired source URLs, and obtaining, from the data on the web pages, a plurality of groups of matching information which matches the received keyword and conforms to a preset searching rule corresponding to the received keyword in the storage device;
determining optimal matching information with the highest occurrence frequency in the groups of matching information; and
outputting the optimal matching information as a search result with a preset format on a display screen of the electronic device.

6. The non-transitory computer-readable medium of claim 5, wherein the storage device stores:
a plurality of keywords and preset searching rules corresponding to each of the keywords, wherein the preset searching rules corresponding to each of the keywords are preset according to statistics and integration of information that matches each of the keywords.

7. The non-transitory computer-readable medium of claim 6, wherein the method further comprises:
determining whether the received keyword is identical to one of the plurality of keywords in the storage device; and
prompting to reenter the keyword or providing one or more related keywords to replace the received keyword when the received keyword is not identical to any one of the plurality of keywords in the storage device.

8. The non-transitory computer-readable medium of claim 5, wherein the method further comprises:
calculating a percentage of the optimal matching information in the groups of match information, wherein the search result comprises the percentage of the optimal matching information.

9. An electronic device comprising:
a display screen;
at least one processor; and
a storage device that stores one or more programs which, when executed by the at least one processor, cause the at least one processor to:
read an image from the storage device;
receive a keyword corresponding to the read image;
transmit the read image;
acquire source uniform resource locators (URLs) of result-of-search pictures which match the read image;
analyze data on web pages of the acquired source URLs, and obtaining, from the data on the web pages, a plurality of groups of matching information which matches the received keyword and conforms to a preset searching rule corresponding to the received keyword in the storage device;
determine optimal matching information with the highest occurrence frequency in the groups of matching information; and
output the optimal matching information as a search result with a preset format on the display screen.

10. The electronic device of claim 9, wherein the storage device stores:
a plurality of keywords and preset searching rules corresponding to each of the keywords, wherein the preset searching rules corresponding to each of the keywords are preset according to statistics and integration of information that matches each of the keywords.

11. The electronic device of clam 10, wherein the at least one processor further:
determines whether the received keyword is identical to one of the plurality of keywords in the storage device; and
prompts to reenter the keyword or provides one or more related keywords to replace the received keyword when the received keyword is not identical to any one of the plurality of keywords in the storage device.

12. The electronic device of claim 9, wherein the at least one processor further:
calculates a percentage of the optimal matching information in the groups of match information, wherein the search result comprises the percentage of the optimal matching information.
